(19) United States
(12) Patent Application Publication
(10) Pub. No.: US 2015/0302365 A1
(43) Pub. Date: Oct. 22, 2015

(54) Method and System for ACH Debit Delayed Availability

(71) Applicant: Bank of America Corporation, Charlotte, NC (US)

(72) Inventors: Dawn M. Patton, Matthews, NC (US); Kevin S. Kauffman, San Francisco, CA (US); Mary S. O'Toole, Plainview, NY (US); John F. Race, Waxhaw, NC (US); Judey L. Thessen, Decatur, GA (US); Vanessa Chung, Petaluma, CA (US); Cheryl E. Robinson, Doraville, GA (US); Barbara J. Watson, Sugar Hill, GA (US); Yvette M.H. Hayes, Richmond, VA (US); Maria L. Mitchell, Arlington, TX (US); Kipling B. Dixon, Windsor, CT (US); Mary N. Sylvester, Jacksonville, FL (US); Susan R. Bushnell, Waxhaw, NC (US); Todd L. Elmquist, Federal Way, WA (US); Frank J. Fogliano, Monroe, NY (US)

(21) Appl. No.: 14/789,310

(22) Filed: Jul. 1, 2015

Related U.S. Application Data
(63) Continuation of application No. 12/894,682, filed on Sep. 30, 2010.

(51) Int. Cl. G06Q 20/02; G06Q 20/10; G06Q 20/26

(52) U.S. Cl. CPC G06Q 20/023; G06Q 20/26; G06Q 20/10

(57) ABSTRACT

A server includes a memory that stores a plurality of availability schedules, and a processor communicatively coupled to the memory. The processor is operable to access an automated clearing house (ACH) debit transaction received at an originating depository financial institution (ODFI) from an originator, determine an availability schedule associated with the originator from the plurality of availability schedules, credit a percentage of the amount of funds of the ACH debit transaction to a delayed settlement account associated with the originator, and transfer a portion of the amount of funds credited to the delayed settlement account to a general operating account of the originator on a particular day determined from the availability schedule. The delayed settlement account has one or more associated rules that prevent the originator from withdrawing funds from the delayed settlement account.

### RELATED APPLICATION

This application is a continuation of U.S. patent Ser. No. 12/894,682, filed Sep. 30, 2010, and entitled Method and System for ACH Debit Delayed Availability, the disclosure of which is hereby incorporated by reference herein.

### TECHNICAL FIELD OF THE INVENTION

The present invention relates generally to financial services and more specifically to a method and system for automated clearing house (ACH) debit delayed availability.

### BACKGROUND OF THE INVENTION

Financial institutions, such as banks, offer many products and services to their clients. One such service is the ability to process automated clearing house (ACH) transactions. For example, a corporate client of a bank may request the bank to initiate an ACH debit from a particular customer of the corporate client. Typically, funds associated with the ACH debit transaction are credited to the corporate client's account regardless of the success of the ACH debit transaction.

### SUMMARY OF THE INVENTION

In accordance with the present invention, the disadvantages and problems associated with prior automated clearing house (ACH) transactions have been substantially reduced or eliminated.

According to one embodiment of the present invention, a server includes a memory that stores a plurality of availability schedules, and a processor communicatively coupled to the memory. The processor is operable to access an ACH debit transaction received at an originating depository financial institution (ODFI) from an originator, determine an availability schedule associated with the originator from the plurality of availability schedules, credit a percentage of the amount of funds of the ACH debit transaction to a delayed settlement account associated with the originator, and transfer a portion of the amount of funds credited to the delayed settlement account to a general operating account of the originator on a particular day determined from the availability schedule. The delayed settlement account has one or more associated rules that prevent the originator from withdrawing funds from the delayed settlement account.

Certain embodiments of the disclosure may provide one or more advantages. An advantage of one embodiment may be that a client of a financial institution may have access to a portion of ACH debit transaction funds while the financial institution is protected from risks associated with failures of ACH debit transactions.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its advantages, reference is now made to the following description taken in conjunction with the accompanying drawings, in which:

FIG. 1 illustrates a system for providing ACH debit delayed availability, according to certain embodiments;

FIG. 2 illustrates embodiments of availability schedules that may be utilized by the system of FIG. 1, according to certain embodiments; and

FIG. 3 illustrates a method for providing ACH debit delayed availability, according to certain embodiments.

### DETAILED DESCRIPTION OF THE INVENTION

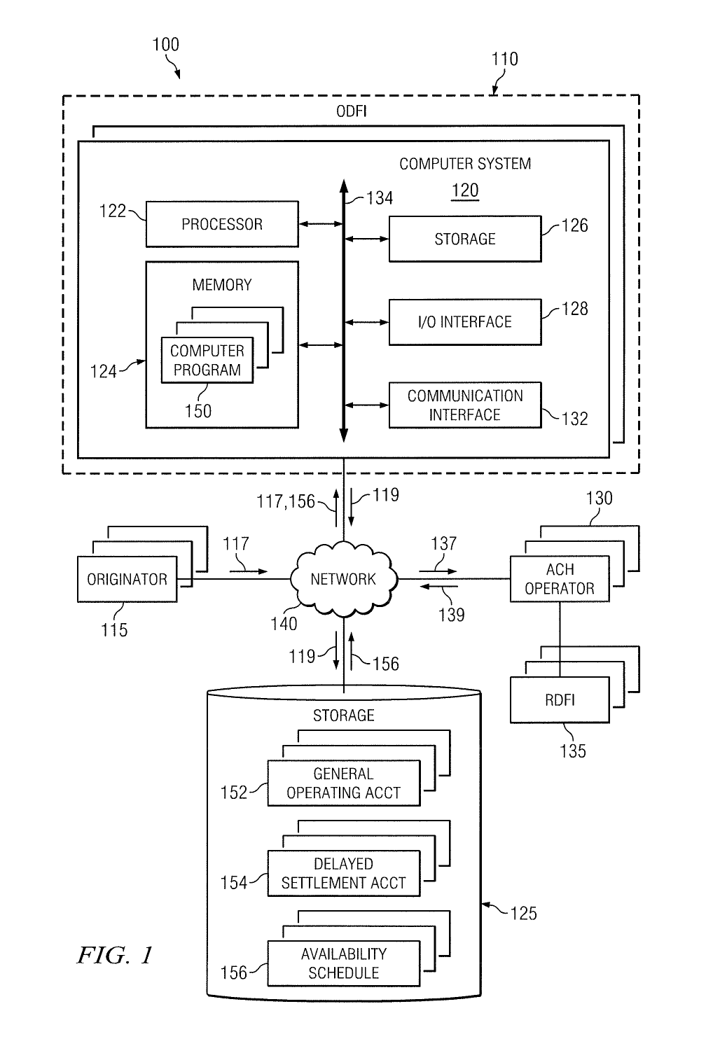

Embodiments of the present invention and its advantages are best understood by referring to FIGS. 1 through 3 of the drawings, like numerals being used for like and corresponding parts of the various drawings.

Banks and other financial institutions typically offer various services to their clients. One service that may be offered is the ability to process automated clearing house (ACH) transactions. For example, a bank may have one or more corporate clients, such as other companies or organizations. The corporate client may in turn have customers who have authorized the corporate client to initiate ACH debit transactions to collect funds for products or services. As a result, the corporate client may transmit the ACH debit transactions to the bank for processing.

After receiving ACH debit transactions from a corporate client, a bank processes the ACH debit transactions by transmitting them to an ACH operator such as a Federal Reserve Bank. Typically, however, the bank will credit the corporate client's account with the funds from the ACH debit transactions before any returns from the ACH debit transactions have been received. For example, banks typically credit the corporate client's account with the funds associated with the ACH debit transactions on a calculated effective date of the ACH debit transactions regardless of the success posting of the ACH debit transactions. Usually, this is one day after receiving the ACH debit transactions. However, this may create unwanted risks for the bank because some ACH debit transactions may later be returned from the ACH operator due to, for example, non-sufficient funds (NSF). As a result, some clients of the bank may not be approved to originate ACH debit transactions.

The teachings of the disclosure recognize that it would be desirable to provide ACH debit processing services to clients of a financial institution without creating unnecessary and unwanted risks to the financial institution due to returned ACH transactions. FIGS. 1 through 3 below illustrate a method and system for ACH debit delayed availability according to the teachings of the disclosure.

FIG. 1 illustrates a system 100 according to certain embodiments. System 100 may include an originating depository financial institutions (ODFI) 110, one or more originators 115, one or more network storage devices 125, one or more computer systems 120, one or more ACH operators 130, and one or more receiving depository financial institutions (RDFI) 135. ODFI 110, originators 115, network storage devices 125, ACH operators 130, and RDFIs 135 may be communicatively coupled by a network 140. ODFI 110 and computer system 120 are generally operable to provide ACH debit delayed services to originators 115, as described below.

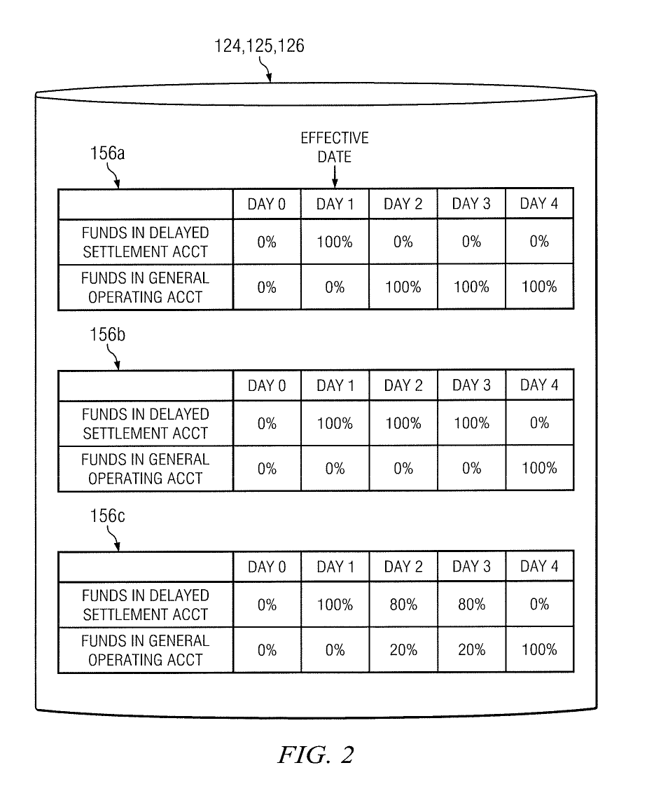

In general, one or more computer systems 120 may offer ACH debit delayed services to originators 115. An originator 115 may first provide one or more ACH debit transactions 117 to ODFI 110. After receiving ACH debit transactions 117, computer system 120 places an amount of funds corresponding to the received ACH debit transactions 117 into a delayed settlement account 154 associated with the originator 115. However, originator 115 is prevented from withdrawing funds from delayed settlement account 154 due to rules associated with delayed settlement account 154. Computer system 120 may then determine an availability schedule 156 for originator 115. Availability schedules 156 indicate when (e.g., Days 0-5) and what percentage (e.g., 0-100%) of the funds placed into delayed settlement account 154 may be made available for withdrawal to originator 115. Certain embodiments of availability schedules 156 are discussed below in reference to FIG. 2. Finally, based on the determined availability schedule 156, computer system 120 transfers some or all of the funds placed into delayed settlement account 154 into a general operating account 152 of originator 115 after a predetermined period of time, thus making the funds available for withdrawal. As a result, originator 115 is provided ACH debit processing services while risks to ODFI 110 due to returned ACH debit transactions are mitigated.

ODFI 110 may refer to any financial institution such as a bank. Originator 115 may refer to any client of ODFI 110. For example, originator 115 may be a corporate client of ODFI 110 and may be any organization such as a business, corporation, firm, government entity, educational entity, or any other organization, regardless of the size of the organization. Originators 115 may utilize any appropriate device to interact with and transmit ACH debit transactions 117 to computer systems 120. In some embodiments, originators 115 may utilize a computer, workstation, telephone, Internet browser, graphical user interface (GUI), electronic notebook, Personal Digital Assistant (PDA), pager, or any other suitable device (wireless, wireline, or otherwise), component, or element capable of receiving, processing, storing, or communicating information with other components of system 100. It will be understood that system 100 may comprise any number and combination of originators 115. Originators 115 transmit ACH debit transactions 117 to ODFI 110 for processing, as described below.

In some embodiments, network storage device 125 may refer to any suitable device communicatively coupled to network 140 and capable of storing and facilitating retrieval of data and/or instructions. Examples of network storage device 125 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. Network storage device 125 may store any data and/or instructions utilized by computer systems 120. In the illustrated embodiment, network storage device 125 stores data related to general operating accounts 152, delayed settlement accounts 154, and availability schedules 156. Operating accounts 152 and delayed settlement accounts 156 may refer to accounts held at ODFI 110 by originators 115 and are described in more detail below. Availability schedules 156 are utilized by computer systems 120 in determining when and what percentage of funds corresponding to ACH debit transactions 117 are transferred from delayed settlement accounts 154 into general operating accounts 152 and made available for withdrawal to originator 115. Certain embodiments of availability schedules 156 are discussed below in reference to FIG. 2.

In certain embodiments, network 140 may refer to any interconnecting system capable of transmitting audio, video, signals, data, messages, or any combination of the preceding. Network 140 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In certain embodiments, ACH operators 130 may refer to any operator that processes ACH transactions. In some embodiments, ACH operators 130 may be Federal Reserve Banks. In some embodiments, ACH operators 130 may be The Clearing House (TCH), formerly known as Electronic Payments Network (EPN). In certain embodiments, ODFI 110 may exchange ACH transactions directly with another financial institution such as RDFI 135, and is not limited to exchanging ACH transactions with ACH operators 130.

In certain embodiments, RDFI 135 may refer to any financial institution where an account referenced by transactions 117 is held. In certain embodiments, RDFI 135 may refer to any other financial institution than ODFI 110. For example, RDFIs 135 may be other banks that hold accounts for customers of originators 115, and transactions 117 may include transactions that request funds from accounts of customers of originators 115 that are held at RDFIs 135. In some embodiments, transactions 117 may request funds from accounts held at ODFI 110, in which case ODFI 110 would also be considered an RDFI 135.

Embodiments of system 100 include one or more computer systems 120 that perform one or more steps of one or more methods described or illustrated herein. In particular embodiments, one or more computer systems 120 provide functionality described or illustrated herein. In particular embodiments, software running on one or more computer systems 120 performs one or more steps of one or more methods described or illustrated herein or provides functionality described or illustrated herein. Particular embodiments include one or more portions of one or more computer systems 120.

This disclosure contemplates any suitable number of computer systems 120. This disclosure contemplates computer system 120 taking any suitable physical form. As example and not by way of limitation, computer system 120 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a server, an application server, or a combination of two or more of these. Where appropriate, computer system 120 may include one or more computer systems 120; be unitary or distributed; span multiple locations; span multiple machines; or reside in a cloud, which may include one or more cloud components in one or more networks. Where appropriate, one or more computer systems 120 may perform without substantial spatial or temporal limitation one or more steps of one or more methods described or illustrated herein. As an example and not by way of limitation, one or more computer systems 120 may perform in real time or in batch mode one or more steps of one or more methods described or illustrated herein. One or more computer systems 120 may perform at different times or at different locations one or more steps of one or more methods described or illustrated herein, where appropriate.

In some embodiments, computer system 120 may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, computer system 120 may be a web server running web server applications such as Apache, Microsoft's Internet Information Server™, and the like.

In particular embodiments, computer system 120 includes a processor 122, memory 124, storage device 126, an input/output (I/O) interface 128, a communication interface 132, and a bus 134. Although this disclosure describes and illustrates a particular computer system having a particular number of particular components in a particular arrangement, this disclosure contemplates any suitable computer system having any suitable number of any suitable components in any suitable arrangement.

In particular embodiments, processor 122 includes hardware for executing instructions, such as those making up a computer program 150. As an example and not by way of limitation, to execute instructions, processor 122 may retrieve (or fetch) the instructions from an internal register, an internal cache, memory 124, or storage device 126; decode and execute the instructions; and then write one or more results to an internal register, an internal cache, memory 124, or storage device 126. In particular embodiments, processor 122 may include one or more internal caches for data, instructions, or addresses. This disclosure contemplates processor 122 including any suitable number of any suitable internal caches, where appropriate. As an example and not by way of limitation, processor 122 may include one or more instruction caches, one or more data caches, and one or more translation lookaside buffers (TLBs). Instructions in the instruction caches may be copies of instructions in memory 124 or storage device 126, and the instruction caches may speed up retrieval of those instructions by processor 122. Data in the data caches may be copies of data in memory 124 or storage device 126 for instructions executing at processor 122 to operate on; the results of previous instructions executed at processor 122 for access by subsequent instructions executing at processor 122 or for writing to memory 124 or storage device 126; or other suitable data. The data caches may speed up read or write operations by processor 122. The TLBs may speed up virtual-address translation for processor 122. In particular embodiments, processor 122 may include one or more internal registers for data, instructions, or addresses. This disclosure contemplates processor 122 including any suitable number of any suitable internal registers, where appropriate. Where appropriate, processor 122 may include one or more arithmetic logic units (ALUs); be a multi-core processor; or include one or more processors 122. Although this disclosure describes and illustrates a particular processor, this disclosure contemplates any suitable processor.

In particular embodiments, memory 124 includes main memory for storing instructions such as computer program(s) 150 for processor 122 to execute, or data for processor 122 to operate on. As an example and not by way of limitation, computer system 120 may load instructions from storage device 126 or another source (e.g., another computer system 120 or network storage device 125) to memory 124. Processor 122 may then load the instructions from memory 124 to an internal register or internal cache. To execute the instructions, processor 122 may retrieve the instructions from the internal register or internal cache and decode them. During or after execution of the instructions, processor 122 may write one or more results (which may be intermediate or final results) to the internal register or internal cache. Processor 122 may then write one or more of those results to memory 124. In particular embodiments, processor 122 executes only instructions in one or more internal registers or internal caches or in memory 124 (as opposed to storage device 126 or elsewhere) and operates only on data in one or more internal registers or internal caches or in memory 124 (as opposed to storage device 126 or elsewhere). One or more memory buses (which may each include an address bus and a data bus) may couple processor 122 to memory 124. Bus 134 may include one or more memory buses, as described below. In particular embodiments, one or more memory management units (MMUs) reside between processor 122 and memory 124 and facilitate accesses to memory 124 requested by processor 122.

In certain embodiments, instructions executed by processor 122 may reside in one or more computer programs 150. Computer program 150 generally refers to instructions, logic, rules, algorithms, code, tables, or other suitable instructions for performing the described functions and operations. In some embodiments, computer programs 150 may be stored in memory 124, storage device 126, network storage device 125, or any other location accessible to computer system 120. Where appropriate, computer program 150 may include one or more computer programs 150; be unitary or distributed; span multiple locations; span multiple machines; or reside in a cloud.

In particular embodiments, storage device 126 includes mass storage for data or instructions such as computer program 150. As an example and not by way of limitation, storage device 126 may include an HDD, a floppy disk drive, flash memory, an optical disc, a magneto-optical disc, magnetic tape, a Universal Serial Bus (USB) drive, a solid-state drive (SSD), or a combination of two or more of these. Storage device 126 may include removable or non-removable (or fixed) media, where appropriate. Storage device 126 may be internal or external to computer system 120, where appropriate. In particular embodiments, storage device 126 is non-volatile, solid-state memory. In particular embodiments, storage device 126 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates storage device 126 taking any suitable physical form. Storage device 126 may include one or more storage control units facilitating communication between processor 122 and storage device 126, where appropriate. Where appropriate, storage device 126 may include one or more storage devices 126. Although this disclosure describes and illustrates particular storage, this disclosure contemplates any suitable storage.

In particular embodiments, I/O interface 128 includes hardware, software, or both providing one or more interfaces for communication between computer system 120 and one or more I/O devices. System 100 may include one or more of these I/O devices, where appropriate. One or more of these I/O devices may enable communication between a person and computer system 120. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. This disclosure contemplates any suitable I/O devices and any suitable I/O interfaces 128 for them. Where appropriate, I/O interface 128 may include one or more devices or software drivers enabling processor 122 to drive one or more of these I/O devices. I/O interface 128 may include one or more I/O interfaces 128, where appropriate. Although this disclosure describes and illustrates a particular I/O interface, this disclosure contemplates any suitable I/O interface.

In particular embodiments, communication interface 132 includes hardware, software, or both providing one or more interfaces for communication (e.g., packet-based communication) between computer system 120 and one or more other computer systems 120 or one or more networks. As an example and not by way of limitation, communication interface 132 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 132 for it. As an example and not by way of limitation, computer system 120 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 120 may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. Computer system 120 may include any suitable communication interface 132 for any of these networks, where appropriate. Communication interface 132 may include one or more communication interfaces 132, where appropriate. Although this disclosure describes and illustrates a particular communication interface, this disclosure contemplates any suitable communication interface.

In particular embodiments, bus 134 includes hardware, software, or both coupling components of computer system 120 to each other. As an example and not by way of limitation, bus 134 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 134 may include one or more buses 134, where appropriate. Although this disclosure describes and illustrates a particular bus, this disclosure contemplates any suitable bus or interconnect. In operation, computer program 150, upon execution by processor 122, provides ACH debit delayed services to originators 115. To provide ACH debit delayed services, computer program 150 may first access transactions 117 received from originators 115. In certain embodiments, transactions 117 may be transmitted to ODFI 110 using Network Data Mover (NDM), FTP, CONNECT:DIRECT, SWIFTAlliance Gateway (SAG), DATA EXPRESS, or any other suitable method for transmitting ACH transactions. In some embodiments, transactions 117 may refer to a National Automated Clearing House Association (NACHA) formatted electronic file that includes one or more ACH debit transactions. As an example, transactions 117 may include one or more ACH debit transactions that indicate an amount of funds to collect from various customers of a corporate client of ODFI 110.

In certain embodiments, transactions 117 may include an effective date. The effective date of transactions 117 may refer to a date in which transactions 117 should be processed by computer program 150. For example, transactions 117 having an effective date that equals the current date are immediately processed by computer program 150. As another example, transactions 117 having an effective date of a day in the future may be warehoused by ODFI 110 until the effective date arrives. Once the effective date of transactions 117 arrives, computer program 150 processes transactions 117 internally to ODFI 110 if the transactions correspond to accounts held at ODFI 110. In addition, computer program 150 directs off-site ACH transactions 137 to be transmitted to ACH operators 130 on the day before the effective date of transactions 117 (where they may subsequently post on the effective date) if the transactions correspond to accounts held at RDFIs 135.

In some situations, ACH operators 130 may transmit returned ACH transactions 139 back to ODFI 110 if off-site ACH transactions 137 fail for any reason. For example, if ACH operator 130 receives an off-site ACH transaction 137 that attempts to debit an account at a particular RDFI 135 that has insufficient funds, ACH operator 130 will transmit a returned ACH transaction 139 back to ODFI 110 indicating a NSF for the particular off-site ACH transaction 137. As another example, if ACH operator 130 receives an off-site ACH transaction 137 that attempts to debit an account at a particular RDFI 135 that is closed or does not exist, ACH operator 130 will transmit a returned ACH transaction 139 back to ODFI 110 indicating a failed transaction.

In certain embodiments, returned ACH transactions 139 may arrive up to 60 days after the effective date of transactions 117. In certain embodiments, the majority of returned ACH transactions 139 arrive at ODFI within two or three days of the effective date of transactions 117. As explained below, however, ODFI 110 may be protected from the risks associated with returned ACH transactions 139 by utilizing delayed settlement accounts 154 to prevent originators 115 from withdrawing funds associated with transactions 117 for a period of time after the effective date.

After receiving transactions 117 from a particular originator 115, computer program 150 determines and accesses a particular availability schedule 156 associated with the particular originator 115. As previously disclosed, availability schedules 156 indicate when (i.e., what day) and what percentage (i.e., 0-100%) of the funds from transactions 117 may be made available for withdrawal to originator 115. In certain embodiments, an availability schedule 156 may be created for a particular originator 115 when the originator 115 becomes a client of ODFI 110. In other embodiments, an availability schedule 156 may be created for a particular originator 115 when the originator 115 enrolls to receive ACH debit delayed services from ODFI 110.

After receiving transactions 117, computer program 150 places an amount of funds 119 corresponding to transactions 117 into a delayed settlement account 154 associated with the originator 115 who transmitted transactions 117. In certain embodiments, the amount of funds 119 is determined from availability schedule 156 corresponding to the originator 115 who transmitted transactions 117. For example, if the total of transactions 117 from a particular originator 115 equals $1000, and the determined availability schedule 156 corresponding to the originator 115 indicates to hold back 100% of the funds of transactions 117 until the second day after the effective date of transactions 117, computer program 150 first posts funds 119 equaling $1000 into delayed settlement account 154 of the particular originator 115 on the effective date of transactions 117. As described below, originators 115 are not permitted to withdraw funds from delayed settlement accounts 154. Then, on the second day after the effective date of transactions 117, computer program 150 facilitates transferring the funds from delayed settlement account 154 into a general operating account 152 associated with the originator 115, thus allowing originator 115 to have full access to the funds. This is in contrast to typical ACH services provided by banks where originators 115 are permitted to withdraw funds associated with transactions 117 when the offset settlement is given on the calculated effective date. Because of the delayed availability of funds, risks to ODFI 110 from returned ACH debit transactions are mitigated.

Unlike general operating accounts 152 that provide full withdrawal capabilities to originators 115, delayed settlement accounts 154 refer to accounts that are associated with originators 115 but that do now allow originators 115 to withdraw any funds from delayed settlement accounts 154. For example, a particular delayed settlement account 154 may be established for a particular originator 115 when the originator 115 becomes a client of ODFI 110, when originator 115 opens general operating account 152, or when originator 115 enrolls to receive ACH debit delayed availability services from ODFI 110. In some embodiments, delayed settlement account 154 may refer to a sub account of an escrow account owned by ODFI 110. On creation of the particular delayed settlement account 154, one or more rules may be established and associated with the particular delayed settlement account 154 in order to prevent any withdrawal of funds. In certain embodiments, for example, rules may be established for the particular delayed settlement account 154 that prevent the owner of the account from withdrawing funds using ACH debits, checks, external debits, or any other available method of withdrawing funds.

As explained above, computer program 150 utilizes availability schedules 156 to determine when and what percentage of the funds associated with transactions 117 to make available for withdrawal to originators 115. FIG. 2 illustrates certain embodiments of availability schedules 156 that may be stored in server memory 124, storage device 126, or network storage device 125, and may be utilized by computer program 150 to provide ACH debit delayed availability according to the teachings of the disclosure. It should be noted that while three particular availability schedules 156a-156c are illustrated in FIG. 2, this disclosure contemplates any appropriate availability schedule 156. For example, certain embodiments of availability schedules 156 may include instructions for the first four days after receiving transactions 117 (i.e., Days 0-5). Other embodiments may include instructions for any number of days after receiving transactions 117. The disclosure is not limited to the illustrated availability schedules 156 in FIG. 2 and merely uses these for illustrative purposes.

Availability schedule 156a illustrates an embodiment where originator 115 is prevented from accessing funds associated with transactions 117 until the day after the effective date of transactions 117. In this embodiment, originator 115 transmits transactions 117 to ODFI 110 on DAY 0. In certain embodiments, transactions 117 have a “next-day” effective date (i.e., DAY 1). In certain embodiments, computer program 150 proceeds on DAY 0 to transmit off-site ACH transactions 137 to ACH operators 130 if the transactions correspond to accounts held at RDFIs 135.

On DAY 1 of availability schedule 156a, computer program 150 places an amount of funds 119 in delayed settlement account 154 of originator 115 that equals 100% of the funds indicated by transactions 117. As illustrated above, originator 115 is not permitted to withdraw any funds from delayed settlement account 154. That is, unlike typical ACH processing where originator 115 is given immediate access to funds from transactions 117, availability schedule 156a instructs computer program 150 to place all of the funds from transactions 117 in delayed settlement account 154 rather than general operating account 152. In certain embodiments, computer program 150 may also, on DAY 1, internally process transactions 117 that correspond to accounts held at ODFI 110. In certain embodiments, the general ledger of ODFI 110 may be adjusted on DAY 1 to reflect the funds transmitted to delayed settlement account 154.

On DAY 2 of availability schedule 156a, which is the first day after the effective date of transactions 117, computer program 150 facilitates transferring 100% of the funds indicated by transactions 117 from delayed settlement account 154 into general operating account 152 of originator 115. Specifically, computer program 150 debits 100% of the funds indicated by transactions 117 from delayed settlement account 154 and credits 100% of the funds indicated by transactions 117 to general operating account 152 of originator 115. As a result, originator 115 may withdraw up to 100% of the funds from transactions 117 on DAY 2, the first day after the effective date of transactions 117. By holding back 100% of the funds in delayed settlement account 154 until DAY 2, risks to ODFI 110 from any returned ACH transactions 139 received before DAY 2 are mitigated.

Availability schedule 156b illustrates a similar embodiment to availability schedule 156a, except that originator 115 must wait an additional two additional days before withdrawing any funds associated with transactions 117. This may be due to factors such as the credit worthiness of originator 115 or account history of originator 115. In availability schedule 156b, originator 115 is prevented from accessing funds associated with transactions 117 until the third day after the effective date of transactions 117. In this embodiment, originator 115 again transmits transactions 117 to ODFI 110 on DAY 0. In certain embodiments, transactions 117 have a “next-day” effective date (i.e., DAY 1). In certain embodiments, computer program 150 transmits off-site ACH transactions 137 to ACH operators 130 on DAY 0 if the transactions correspond to accounts held at RDFIs 135.

On DAY 1 of availability schedule 156b, computer program 150 facilitates placing an amount of funds 119 in delayed settlement account 154 of originator 115 that equals 100% of the funds indicated by transactions 117. As illustrated above, originator 115 is not permitted to withdraw any funds from delayed settlement account 154. In certain embodiments, computer program 150 may also internally process transactions 117 that correspond to accounts held at ODFI 110 on DAY 1 of availability schedule 156b.

On DAYS 2 and 3 of availability schedule 156b, no funds are transferred from delayed settlement account 154. On DAY 4 of availability schedule 156b, which is the third day after the effective date of transactions 117, computer program 150 facilitates transferring 100% of the funds indicated by transactions 117 from delayed settlement account 154 into general operating account 152 of originator 115. As a result, originator 115 may withdraw up to 100% of the funds from transactions 117 on DAY 4, the third day after the effective date of transactions 117. By holding back 100% of the funds in delayed settlement account 154 until DAY 4, risks to ODFI 110 from any returned ACH transactions 139 received before DAY 4 are mitigated.

Availability schedule 156c illustrates an embodiment where computer program 150 facilitates splitting the settlement of transactions 117 over more than one day. That is, originator 115 is given access to a percentage of the funds from transactions 117 on a certain day, and then is given access to the remaining portion of the funds on another day. In this embodiment, originator 115 again transmits transactions 117 to ODFI 110 on DAY 0. In certain embodiments, transactions 117 have a “next-day” effective date (i.e., DAY 1). In certain embodiments, computer program 150 proceeds on DAY 0 to transmit off-site ACH transactions 137 to ACH operators 130 if the transactions correspond to accounts held at RDFIs 135.

On DAY 1 of availability schedule 156c, computer program 150 facilitates placing an amount of funds 119 in delayed settlement account 154 of originator 115 that equals 100% of the funds indicated by transactions 117. As illustrated above, originator 115 is not permitted to withdraw any funds from delayed settlement account 154. In certain embodiments, computer program 150 may also internally process transactions 117 that correspond to accounts held at ODFI 110 on DAY 1 of availability schedule 156c.

On DAY 2 of availability schedule 156c, which is the first day after the effective date of transactions 117, computer program 150 facilitates transferring 20% of the funds indicated by transactions 117 from delayed settlement account 154 into general operating account 152 of originator 115. As a result, originator 115 may withdraw up to 20% of the funds from transactions 117 on DAY 2, the second day after the effective date of transactions 117. By holding back 80% of the funds in delayed settlement account 154 until at least DAY 2, risks to ODFI 110 from any returned ACH transactions 139 received before DAY 2 are mitigated.

On DAY 3 of availability schedule 156c, no funds are transferred from delayed settlement account 154. That is, on DAY 3 of availability schedule 156c, 80% of the funds indicated by transactions 117 remain in delayed settlement account 154. On DAY 4 of availability schedule 156c, computer program 150 facilitates transferring the remaining 80% of the funds indicated by transactions 117 from delayed settlement account 154 into general operating account 152 of originator 115. As a result, originator 115 may withdraw up to 100% of the funds from transactions 117 on DAY 4, the third day after the effective date of transactions 117. By holding back 80% of the funds in delayed settlement account 154 until DAY 4, risks to ODFI 110 from any returned ACH transactions 139 received before DAY 4 are mitigated.

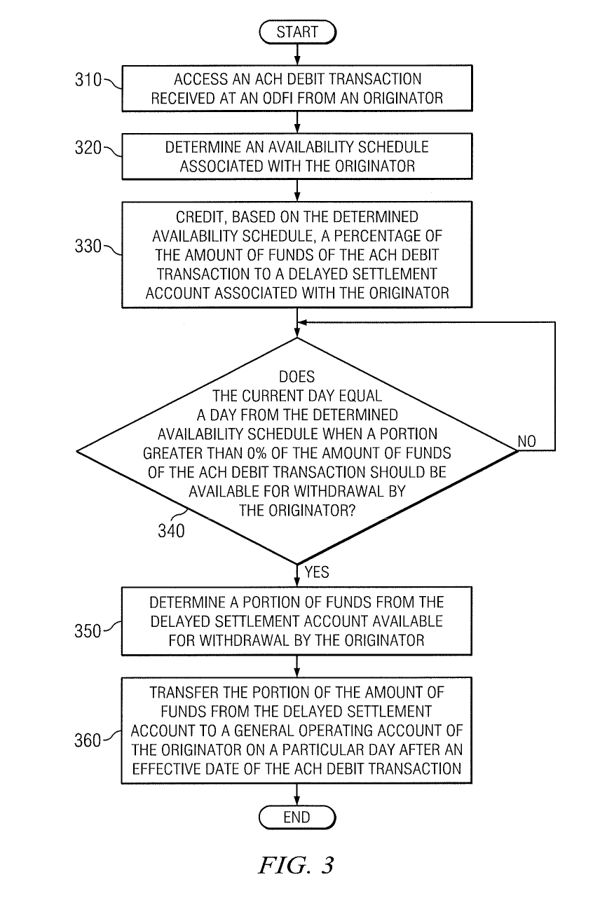

FIG. 3 illustrates one embodiment of a method 300 for providing ACH debit delayed services to originators 115. Method 300 may be implemented, for example, by one or more computer programs 150 in computer systems 120. Method 300 begins in step 310 where an ACH debit transaction received at an originating depository financial institution from the originator is accessed. In some embodiments, the ACH debit transaction may be transaction 117 described above. In certain embodiments, the originating depository financial institution may refer to ODFI 110 described above.

In step 320, an availability schedule associated with the originator is determined from a plurality of availability schedules stored in memory. In certain embodiments, for example, the determined availability schedule may refer to availability schedules 156 described above. In certain embodiments, the determined availability schedule may refer to availability schedules 156a-156c described above, or any other suitable availability schedule.

In step 330, a percentage of the amount of funds of the ACH debit transaction is credited to a delayed settlement account associated with the originator based on the determined availability schedule. In certain embodiments, the delayed settlement account has one or more associated rules that prevent the originator from withdrawing funds from the delayed settlement account. In certain embodiments, the delayed settlement account may refer to delayed settlement accounts 154 described above.

In step 340, a decision is made whether or not to proceed to step 350. In step 340, if the current day equals a day from the availability schedule determined in step 320 when a portion greater than 0% of the amount of funds of the ACH debit transaction should be available for withdrawal by the originator, method 300 proceeds to step 350 described below. Otherwise, method 300 proceeds back to step 340.

In step 350, a portion of funds from the delayed settlement account available for withdrawal by the originator is determined. In certain embodiments, the portion of funds in step 350 is determined by the availability schedule determined in step 320.

In step 360, a portion of the amount of funds credited to the delayed settlement account in step 330 is transferred to a general operating account of the originator where the originator is then permitted to withdraw the portion of the funds. In certain embodiments, the portion of the amount of funds are transferred to the general operating account of the originator on a particular day according to the availability schedule determined in step 320. In certain embodiments, the general operating account of the originator may refer to general operating account 152 described above. After step 350, method 300 ends.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, capable, configured, enabled, operable, or operative.

What is claimed is:

1. A server, comprising:
a memory operable to store a plurality of availability schedules, each availability schedule indicating when funds from an automated clearing house (ACH) debit transaction are available for withdrawal by an originator; and
a processor associated with an originating depository financial institution (ODFI), the processor communicatively coupled to the memory and operable to:
maintain a first account and a second account for a customer of the ODFI, the customer identified as the originator and payee of the ACH debit transaction;
determine an availability schedule associated with the originator from the plurality of availability schedules;
prior to an effective date of the ACH debit transaction, credit an amount of funds corresponding to the ACH debit transaction to the first account associated with the customer identified as the originator and payee of the ACH debit transaction, the effective date comprising a date on which the ACH debit transaction is to be processed, the first account comprising a delayed settlement account associated with the originator, the delayed settlement account having one or more associated rules prohibiting the originator from withdrawing funds from the delayed settlement account; and
transfer a portion of the amount of funds credited to the delayed settlement account associated with the customer identified as the originator and the payee to the second account that is also associated with the same customer, the second account comprising a general operating account of the customer, the transfer of the portion of the amount of funds to the second account being performed on a particular day determined from the availability schedule, the customer being permitted to withdraw the portion of the funds credited to the general operating account.

2. The server of claim 1, wherein the one or more associated rules preventing the originator from withdrawing funds from the delayed settlement account comprise a rule to prevent the originator from conducting ACH debit transactions on the delayed settlement account.

3. The server of claim 1, wherein the one or more associated rules preventing the originator from withdrawing funds from the delayed settlement account comprise a rule to prevent the originator from posting checks on the delayed settlement account.

4. The server of claim 1, wherein the ACH debit transaction indicates an amount of funds to collect from a selected one of an account held at a receiving depository financial institution (RDFI) or from an account held at the ODFI.

5. The server of claim 1, wherein the particular day is at least one day after the effective date of the ACH debit transaction as determined based on the determined availability schedule.

6. A method comprising:
receiving, by an originating depository financial institution (ODFI), an automated clearing house (ACH) debit transaction from an originator;
maintaining, by a computing system associated with the ODFI, a first account and a second account for a customer of the ODFI, the customer identified as the originator and payee of the ACH debit transaction;
determining, by the computing system, an availability schedule associated with the originator, the availability schedule indicating when the amount of funds of the ACH debit transaction are available for withdrawal by the originator;
prior to an effective date of the ACH debit transaction, crediting, by the computing system, the amount of funds of the ACH debit transaction to the first account associated with the customer identified as the originator and payee of the ACH debit transaction, the effective date comprising a date on which the ACH debit transaction is to be processed, the first account comprising a delayed settlement account associated with the originator, the delayed settlement account having one or more associated rules prohibiting the originator from withdrawing funds from the delayed settlement account; and
transferring, by the computing system, a portion of the amount of funds credited to the delayed settlement account associated with the customer identified as the originator and the payee to the second account that is also associated with the same customer, the second account comprising a general operating account of the customer, the transfer of the portion of the amount of funds to the second account being performed on a particular day determined from the availability schedule, the customer being permitted to withdraw the portion of the funds credited to the general operating account.

7. The method of claim 6, wherein the one or more associated rules preventing the originator from withdrawing funds from the delayed settlement account comprise a rule to prevent the originator from conducting ACH debit transactions on the delayed settlement account.

8. The method of claim 6, wherein the one or more associated rules preventing the originator from withdrawing funds from the delayed settlement account comprise a rule to prevent the originator from posting checks on the delayed settlement account.

9. The method of claim 6, wherein the ACH debit transaction indicates an amount of funds to collect from a selected one of an account held at a receiving depository financial institution (RDFI) or from an account held at the ODFI.

10. The method of claim 6, wherein the particular day is at least one day after the effective date of the ACH debit transaction as determined based on the determined availability schedule.

11. A system, comprising:
a storage device operable to store a plurality of availability schedules, each availability schedule indicating when funds from an automated clearing house (ACH) debit transaction are available for withdrawal by an originator; and
a server communicatively coupled to the storage device, the server comprising a processor;
wherein the server is operable to:
maintain a first account and a second account for a customer of an originating depository financial institution (ODFI), the customer identified as the originator and payee of the ACH debit transaction;
determine an availability schedule associated with the originator from the plurality of availability schedules stored in the storage device;
prior to an effective date of the ACH debit transaction, credit an amount of funds corresponding to the ACH debit transaction to the first account associated with the customer identified as the originator and payee of the ACH debit transaction, the effective date comprising a date on which the ACH debit transaction is to be processed, the first account comprising a delayed settlement account associated with the originator, the delayed settlement account having one or more associated rules prohibiting the originator from withdrawing funds from the delayed settlement account; and
transfer a portion of the amount of funds credited to the delayed settlement account associated with the customer identified as the originator and the payee to the second account that is also associated with the same customer, the second account comprising a general operating account of the customer, the transfer of the portion of the amount of funds to the second account being performed on a particular day determined from the availability schedule, the customer being permitted to withdraw the portion of the funds credited to the general operating account.

12. The system of claim 11, wherein the one or more associated rules preventing the originator from withdrawing funds from the delayed settlement account comprise a rule to prevent the originator from conducting ACH debit transactions on the delayed settlement account.

13. The system of claim 11, wherein the one or more associated rules preventing the originator from withdrawing funds from the delayed settlement account comprise a rule to prevent the originator from posting checks on the delayed settlement account.

14. The system of claim 11, wherein the ACH debit transaction indicates an amount of funds to collect from a selected one of an account held at a receiving depository financial institution (RDFI) or from an account held at the ODFI.

15. The system of claim 11, wherein the particular day is at least one day after the effective date of the ACH debit transaction as determined based on the determined availability schedule.

16. One or more computer-readable non-transitory storage media embodying software this is operable when executed by one or more computer systems to:
maintain a first account and a second account for a customer of an originating depository financial institution (ODFI), the customer identified as the originator and payee of the ACH debit transaction;
determine an availability schedule associated with the originator, the availability schedule indicating when the amount of funds of the ACH debit transaction are available for withdrawal by the originator;
prior to an effective date of the ACH debit transaction, credit an amount of funds corresponding to the ACH debit transaction to the first account associated with the customer identified as the originator and payee of the ACH debit transaction, the effective date comprising a date on which the ACH debit transaction is to be processed, the first account comprising a delayed settlement account associated with the originator, the delayed settlement account having one or more associated rules prohibiting the originator from withdrawing funds from the delayed settlement account; and
transfer a portion of the amount of funds credited to the delayed settlement account associated with the customer identified as the originator and the payee to the second account that is also associated with the same customer, the second account comprising a general operating account of the customer, the transfer of the portion of the amount of funds to the second account being performed on a particular day determined from the availability schedule, the customer being permitted to withdraw the portion of the funds credited to the general operating account.

17. The non-transitory media of claim 16, wherein the one or more associated rules preventing the originator from withdrawing funds from the delayed settlement account comprise a rule to prevent the originator from conducting ACH debit transactions on the delayed settlement account.

18. The non-transitory media of claim 16, wherein the one or more associated rules preventing the originator from withdrawing funds from the delayed settlement account comprise a rule to prevent the originator from posting checks on the delayed settlement account.

19. The non-transitory media of claim 16, wherein the ACH debit transaction indicates an amount of funds to collect from a selected one of an account held at a receiving depository financial institution (RDFI) or from an account held at the ODFI.

20. The non-transitory media of claim 16, wherein the particular day is at least one day after the effective date of the ACH debit transaction as determined based on the determined availability schedule.
